(19) United States
(12) Patent Application Publication
(10) Pub. No.: US 2026/0113138 A1
(43) Pub. Date: Apr. 23, 2026

(54) Optical Line System Physical Digital Model Calibration Using a Differential Algorithm

(71) Applicant: NEC Laboratories America, Inc., Princeton, NJ (US)

(72) Inventor: Giacomo Borraccini, Plainsboro, NJ (US)

(73) Assignee: NEC Laboratories America, Inc., Princeton, NJ (US)

(21) Appl. No.: 19/359,176

(22) Filed: Oct. 15, 2025

Related U.S. Application Data
(60) Provisional application No. 63/708,451, filed on Oct. 17, 2024.

(51) Int. Cl. H04J 14/02; H04B 10/079

(52) U.S. Cl. CPC H04J 14/0282; H04B 10/07955

(57) ABSTRACT

A differential algorithm and method for calibrating a physical digital model, or digital twin, of an optical line system (OLS) is provided. The OLS comprises a multi-span optical link with a plurality of Erbium-Doped Fiber Amplifiers (EDFAs), each having integrated total power monitors, and optical fiber spans. The method utilizes a minimal, pre-defined set of measurements organized into at least a first dataset and a second dataset. The calibration process segments the problem by using the first dataset to extract total fiber attenuation profiles. The second dataset is used in a deterministic, feature-extraction process that iteratively analyzes the EDFAs from the last stage to the first stage. This analysis involves computing numerical derivatives of measured signal and noise power profiles with respect to target EDFA control parameters.

### CROSS REFERENCE TO RELATED APPLICATIONS

This application claims the benefit of U.S. Provisional Patent Application Ser. No. 63/708,451 filed Oct. 17, 2024, the entire contents of which is incorporated by reference as if set forth at length herein.

### FIELD OF THE INVENTION

This application relates generally to optical communications and networks constructed therefrom. More particularly, it pertains to optical line system physical digital model calibration using a differential algorithm.

### BACKGROUND OF THE INVENTION

The rapid expansion of optical network deployment demands advanced management strategies to ensure efficiency and scalability. Automation, enabled by the implementation of digital twins, has emerged as a pivotal solution in this domain. As those skilled in the art will understand and appreciate, digital twins provide real-time simulation and modeling of physical network components, facilitating proactive maintenance and optimization without disrupting live operations.

A recent trend toward the opening and disaggregation of optical networks introduces additional complexity that requires comprehensive information from the physical layer of the optical networks for effective orchestration. Access to detailed physical layer data is essential for managing heterogeneous network elements and ensuring seamless interoperability among diverse systems.

To address these needs, operators are increasingly adopting terminal-based technologies and leveraging open-source tools to automatically extract physical features of the network. This approach eliminates the need for personnel dispatching, thereby reducing operational costs and accelerating the commissioning phase. As a result, optical networks can become operational more rapidly, enhancing service delivery and competitiveness.

However, minimally monitored infrastructures, while cost-effective in terms of installation and maintenance, present difficulties in control and optimization due to limited visibility into network performance. Focusing on the optical transmission, in multi-span optical lines the only available monitors are photodetectors embedded within each erbium-doped fiber amplifier (EDFA), measuring the total optical power. This transmission scenario is common in several legacy systems and represents a frequent implementation among network operators, thanks to its simple management, with few monitoring data streams and a simple telemetry control system, and low equipment installation cost. Balancing cost with the need for effective monitoring is a critical concern. Enhancing the accuracy of network planning and optimization becomes imperative to maximize resource utilization and maintain high-quality service delivery. Advanced analytical methods and precise physical layer information are essential components in achieving these objectives.

### SUMMARY OF THE INVENTION

An advance in the art is made according to aspects of the present disclosure directed to an optical line system physical digital model calibration using a differential algorithm.

In sharp contrast to the prior art—and given a digital physical layer model for EDFAs and optical fibers—my inventive calibration methodology allows retrieval of needed physical parameters to reproduce measured behavior of a system under examination in terms of optical signal-to-noise ratio (OSNR). The inventive procedure involves two consecutive steps:
i) datasets acquisition, fixing once the input spectrum—the total power at the booster input is designed as the difference between its maximum output power and maximum gain, allowing to swipe along the whole dynamics of the booster—and changing the configuration of EDFAs; and
ii) calibration (optimization) of the physical parameters of the digital model to have match between the simulated metrics (signal or ASE noise power) and the measures considering the same working condition.

The procedure retrieves the physical characteristics of both EDFAs and optical fibers without any device pre-characterization, only knowing EDFA operational ranges (amplification band limits, total power, gain and tilt). Then, the methodology exploits a minimal number of pre-defined measurements, each one measuring the system in a different specific configuration of EDFA target parameters by using all total power monitors and an optical spectrum analyzer (OSA) at the line termination.

As will be shown and described, my inventive approach results in a significant improvement over the prior art regarding the calibration of a physical digital model of an optical propagation line system completely from scratch, moving from a heuristic to a deterministic approach by segmenting the problem into smaller subtasks. Shown and described further in addition to the algorithm that provides the acquisition of the minimum measurements for the calibration, it is also shown how the information is used to characterize each physical property of the system separately, retrieving both fiber and EDFA physical parameters. As a result, a more robust evaluation of the physical contributions provided by each device along the optical line is produced.

### BRIEF DESCRIPTION OF THE DRAWING

FIG. 1 is a schematic diagram showing illustrative two steps of my inventive procedure according to aspects of the present disclosure.

FIG. 2 shows illustrative pseudo-code for the step 1 of my inventive procedure according to aspects of the present disclosure.

FIG. 3 shows illustrative pseudo-code for the step 2 of my inventive procedure according to aspects of the present disclosure.

FIG. 4 is a schematic diagram showing an illustrative experimental setup of the optical line system under test according to aspects of the present invention.

FIG. 5 is a plot of an example spectra created by the multiplexer (MUX) shaping the ASE noise source during the first dataset acquisition according to aspects of the present disclosure.

FIG. 6 shows illustrative pseudo-code for algorithm for dataset collection according to aspects of the present disclosure.

FIG. 7 is a plot showing illustrative physical parameters extracted intrinsic ripple profile, gain, g₀, and noise figure, nf₀ according to aspects of the present invention.

FIG. 8 is a plot showing illustrative physical parameters extracted of gain ripple first derivative vs. tilt target according to aspects of the present invention.

FIG. 9 is a plot showing illustrative physical parameters extracted of initial value of the gain ripple first derivative vs. gain target according to aspects of the present invention.

FIG. 10 is a plot showing illustrative physical parameters extracted of gain ripple second derivative vs gain target according to aspects of the present invention.

FIG. 11 is a plot showing illustrative physical parameters extracted of average noise figure curve vs gain and tilt target according to aspects of the present invention.

FIG. 12 is a plot showing illustrative physical parameters extracted of noise figure ripple first derivative vs tilt target according to aspects of the present invention.

FIG. 13 is a plot showing illustrative physical parameters extracted of noise figure ripple first derivative vs gain target according to aspects of the present invention.

FIG. 14 is a plot showing illustrative physical parameters extracted noise figure ripple first derivative vs gain target according to aspects of the present invention.

FIG. 15 is a plot showing illustrative experimental results obtained on a validation dataset of 100 measurements with random chosen combination of EDFA target setting for heat maps of signal and OSNR error over frequency in which all results have been achieved collecting a validation dataset of 100 measurements for every OLS according to aspects of the present invention.

FIG. 16 is a plot showing illustrative experimental results obtained on a validation dataset of 100 measurements with random chosen combination of EDFA target setting for distributions of signal and OSNR error using different metrics in which all results have been achieved collecting a validation dataset of 100 measurements for every OLS according to aspects of the present invention.

FIG. 17 is a plot showing illustrative experimental results obtained on a validation dataset of 100 measurements with random chosen combination of EDFA target setting for histograms of the average metrics for signal and OSNR error incrementing histograms of the average metrics for signal and OSNR error incrementing the number of spans in the OLS in which all results have been achieved collecting a validation dataset of 100 measurements for every OLS according to aspects of the present invention.

FIG. 18 is a plot showing illustrative experimental results obtained on a validation dataset of 100 measurements with random chosen combination of EDFA target setting for heat maps of signal and OSNR error over frequency in which all results have been achieved collecting a validation dataset of 100 measurements for every OLS according to aspects of the present invention.

FIG. 19 is a plot showing illustrative experimental results obtained on a validation dataset of 100 measurements with random chosen combination of EDFA target setting for distributions of signal and OSNR error using different metrics in which all results have been achieved collecting a validation dataset of 100 measurements for every OLS according to aspects of the present invention.

FIG. 20 is a plot showing illustrative experimental results obtained on a validation dataset of 100 measurements with random chosen combination of EDFA target setting for histograms of the average metrics for signal and OSNR error incrementing histograms of the average metrics for signal and OSNR error incrementing the number of spans in the OLS in which all results have been achieved collecting a validation dataset of 100 measurements for every OLS according to aspects of the present invention.

FIG. 21 is a schematic diagram showing an illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

To show and describe my inventive approach, a transmission scenario for a multi-span EDF-amplified optical link between two adjacent reconfigurable optical add & drop multiplexers (ROADMs) within a given optical network where each EDFA has integrated total power monitors at each terminal is considered.

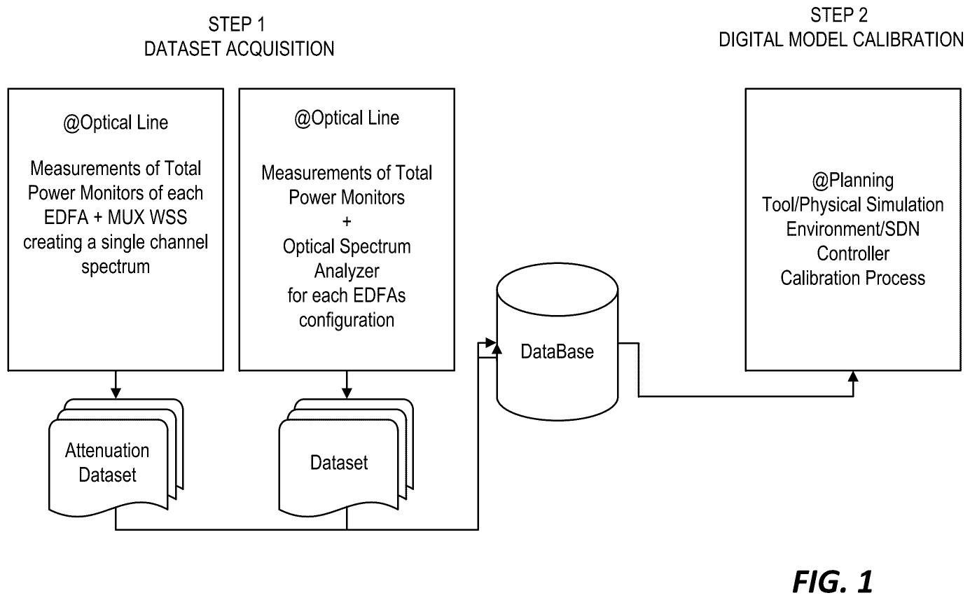

FIG. 1 is a schematic diagram showing illustrative two steps of my inventive procedure according to aspects of the present disclosure.

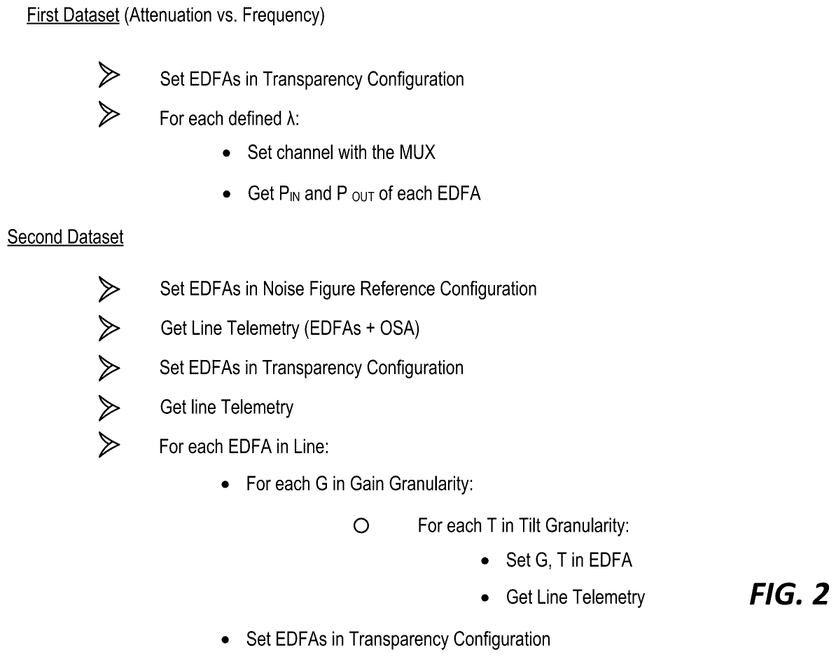

FIG. 2 shows illustrative pseudo-code for the step 1 of my inventive procedure according to aspects of the present disclosure.

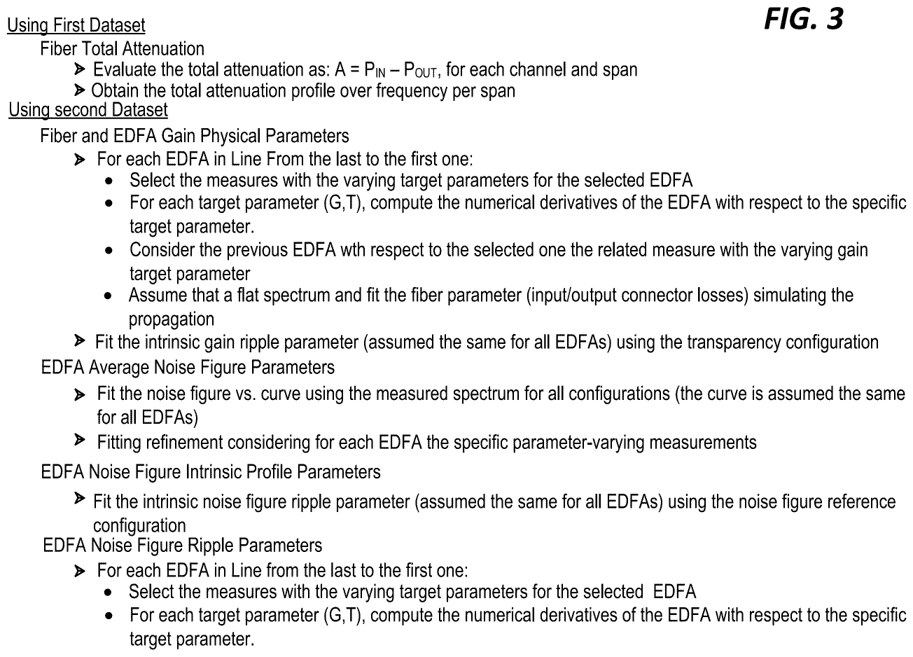

FIG. 3 shows illustrative pseudo-code for the step 2 of my inventive procedure according to aspects of the present disclosure.

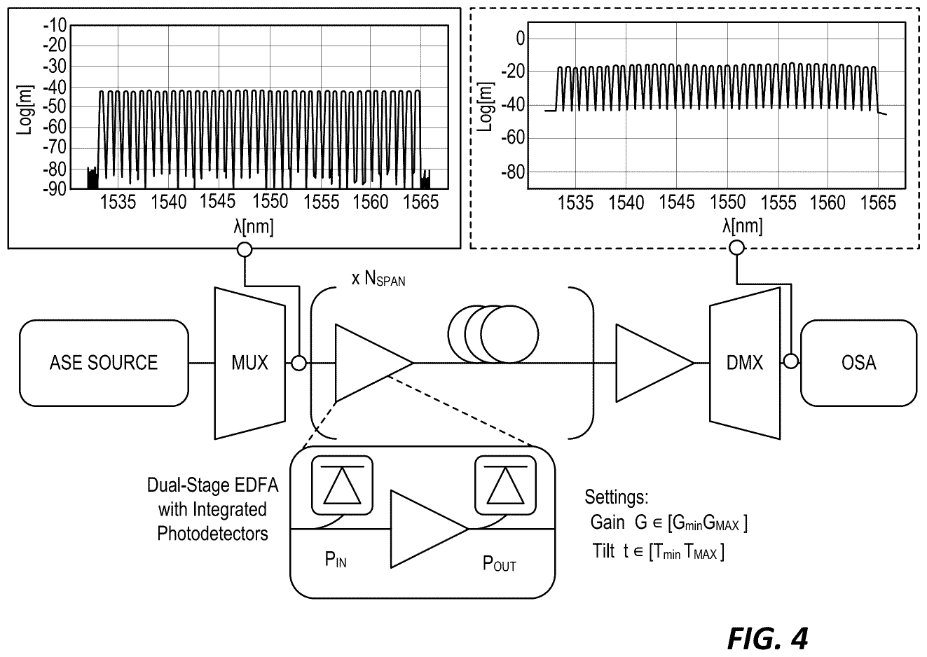

FIG. 4 is a schematic diagram showing an illustrative experimental setup of the optical line system under test according to aspects of the present invention.

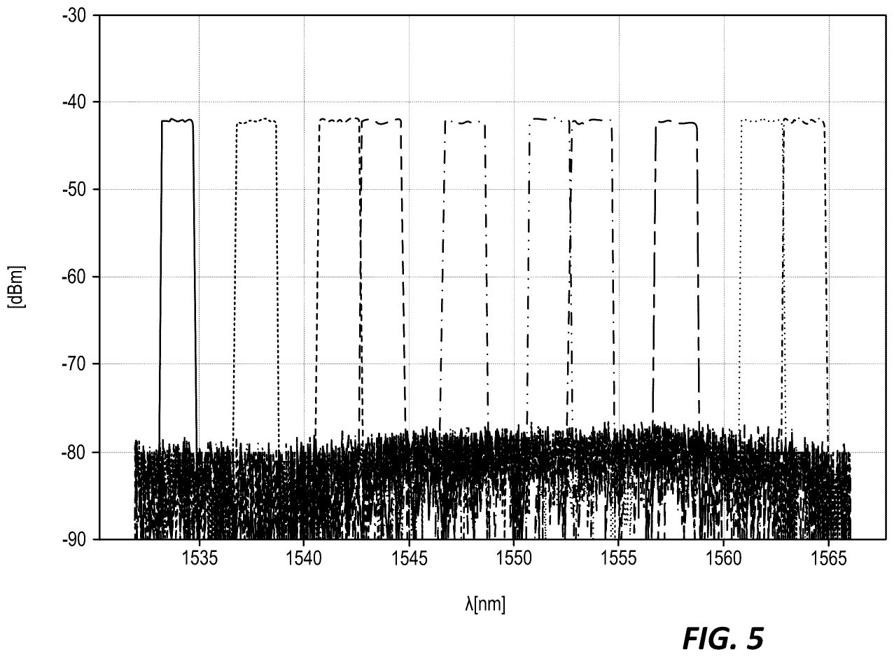

FIG. 5 is a plot of an example spectra created by the multiplexer (MUX) shaping the ASE noise source during the first dataset acquisition according to aspects of the present disclosure.

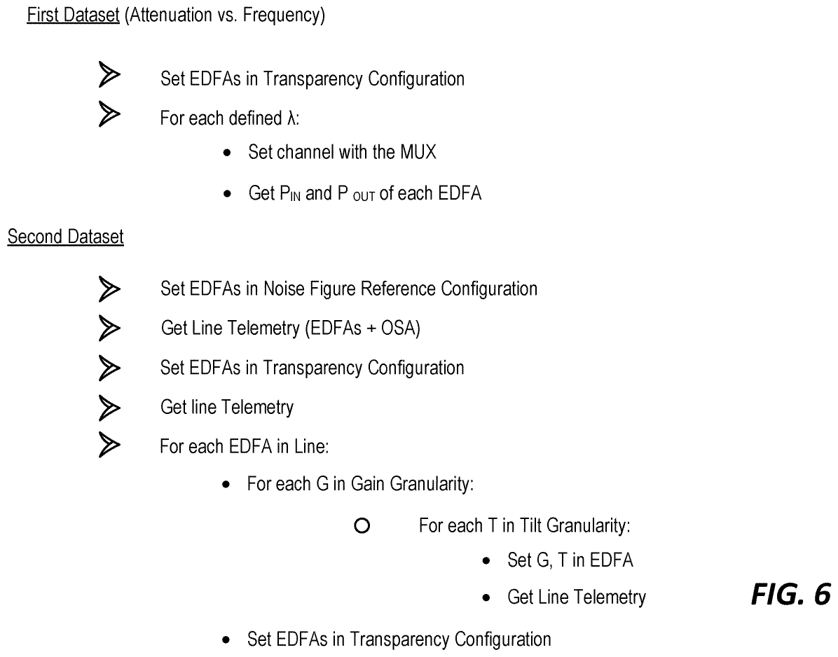

FIG. 6 shows illustrative pseudo-code for algorithm for dataset collection according to aspects of the present disclosure.

With simultaneous reference to the above figures, the inventive calibration methodology is based on the following requirements:

EDFAs are dual-stage amplifiers and provide automatic gain control (AGC), setting both gain and tilt as target parameters.

The procedure is performed after the installation of the cable and before the beginning of networking operations.

The additional equipment needed are an amplified spontaneous emission (ASE) source, generating a full channel load at the transmitter, and an optical spectrum analyzer (OSA), measuring the spectrum at the receiver.

For the acquisition of the first dataset, the procedure requires the use of an input propagating spectrum with a single channel, generated by means of the ROADM wavelength selective switch (WSS) to measure the fiber loss at the created channel frequency.

For the acquisition of the second dataset, the procedure requires the use of an input propagating spectrum with every other channel, generated by means of the ROADM wavelength selective switch (WSS) to measure both the channel and ASE noise power—i.e., 40˜active channels in 50˜GHz full C-band grid.

Considering a certain EDFAs working point configuration of gain and tilt targets, a single optical line measurement consists of the set of EDFA monitoring information and OSA measurement. The latter is post-processed to obtain the signal and ASE power profiles at the receiver.

The objective of the first step is to locally change the properties of each device—gain ripple profile and noise figure for EDFAs, or stimulated Raman scattering (SRS) for optical fibers—modifying the working point of the EDFAs and measuring the accumulation of the effects using the OSA. First, the optical line is set in transparency configuration, where each EDFA recovers the loss introduced by the previous span. If not specified, all EDFAs are set at the same tilt value making flat the spectrum profile at the receiver for the set booster gain.

Two datasets are collected focused on the calibration of different groups of physical parameters (FIG. 3(C)). To obtain the first dataset, start by configuring the EDFAs to operate in Transparency Mode. For each predefined wavelength (FIG. 3(B), set the appropriate channel using the multiplexer (MUX), and then measure the input and output power of each EDFA. This process will provide the necessary data to analyze attenuation as a function of frequency.

For the second dataset, begin by configuring the EDFAs in the Noise Figure Reference Mode. Once this is set, gather line telemetry data using both the EDFAs and an Optical Spectrum Analyzer (OSA). Next, switch the EDFAs back to Transparency Mode and collect the telemetry data again. For each EDFA in the line, adjust the gain settings over a specified range, and within each gain setting, vary the tilt across a defined range. After each adjustment, record the telemetry data. Once all configurations have been tested, reset the EDFAs to Transparency Mode. This procedure will yield a comprehensive dataset that covers both noise figure and gain-tilt performance across the optical line.

The total number of measurements for the second dataset is 2+n_{G}*n_{T}*N_{EDFA}, where N_{EDFA} is the number of EDFAs along the line, n_{G} and n_{T} are the chosen numbers of gain and tilt values defining the granularity of the third dataset.

The second step (digital model calibration) involves the use of the two datasets and aims to calibrate the digital model physical parameters throughout a feature extraction process based on following extraction algorithm.

Using the first dataset, the total fiber attenuation is calculated by subtracting the output power (P_OUT) from the input power (P_IN) for each channel and span. This allows for the creation of an attenuation profile over frequency for each span, providing insights into how the signal weakens over the transmission line.

Using the second dataset, the physical parameters of the fiber and gain are determined by analyzing the variations of each EDFA in the line, starting from the last to the first. For each EDFA, measurements are grouped for varying target parameters, gain (G) and tilt (T). For each target parameter, numerical derivatives of the selected EDFA to these parameters are computed considering the measured signal power profiles and target parameter setting variations. Then, the algorithm considers the measures related to the previous EDFA with respect to the selected one with the gain target setting varying. Assuming a flat spectrum at the input of the fiber span in between the two amplifiers, the fiber parameters (input/output connector losses), are fitted to match the signal power spectrum variation at the end of the line. The same procedure is applied iteratively to all the optical line spans up to the booster amplifier. Then, the intrinsic gain ripple parameter, g₀, assumed to be the same for all EDFAs, is then fitted for the transparency configuration.

For the EDFA noise figure, the average noise figure curve is fitted using the measured spectrum across all configurations, with the curve assumed to be the same for all EDFAs. The fitting is refined for each EDFA, considering the measurements that vary according to specific varying target parameter configurations.

To obtain the intrinsic profile of the noise figure, it is fitted (assumed to be identical for all EDFAs) based on the noise figure reference configuration. This configuration is defined setting all EDFAs at a unique value of both gain and tilt target parameters within the granularity grids (n_{G} and n_{T}).

Finally, the noise figure ripple parameters for each EDFA are analyzed again starting from the last to the first EDFA in the line. Measurements are selected based on varying target parameters for each EDFA. For each target parameter (G and T), the numerical derivatives of the noise figure ripple profile for the selected EDFA are computed with respect to the corresponding target parameter considering the measured amplified spontaneous emission (ASE) power profiles and target parameter setting variations.

### EXPERIMENTAL

As previously noted, an improvement over the prior art is presented regarding the calibration of the physical digital model of an optical propagation line system completely from scratch, moving from a heuristic to a deterministic approach by segmenting the problem into smaller subtasks. In addition to the algorithm that provides the acquisition of the minimum measurements for the calibration, it is also shown how in the data processing the information is used to characterize each physical property of the system separately, retrieving both fiber and EDFA physical parameters. Additionally, the use of a novel EDFA model based on numerical derivatives for the ripple estimation of both gain and noise figure spectra is described in more detail.

The considered transmission scenario is a multi-span EDF-amplified optical link between two adjacent reconfigurable optical add & drop multiplexers (ROADMs) within a given optical network where each EDFA has integrated total power monitors at each terminal. The calibration methodology is based on the following requirements: i) EDFAs are dual-stage amplifiers and provide automatic gain control (AGC), setting both gain and tilt as target parameters. ii) The procedure is performed after the installation of the cable and before the beginning of networking operations. iii) The additional equipment needed are an amplified spontaneous emission (ASE) source, generating a full channel load at the transmitter, and an optical spectrum analyzer (OSA), measuring the spectrum at the receiver. iv) For the acquisition of the first dataset, the procedure requires the use of an input propagating spectrum with a single channel, generated by means of the ROADM wavelength selective switch (WSS) to measure the fiber loss at the created channel frequency. v) For the acquisition of the second dataset, the procedure requires the use of an input propagating spectrum with every other channel, generated by means of the ROADM wavelength selective switch (WSS) to measure both the channel and ASE noise power—i.e., 40 active channels in 50 GHz full C-band grid.

Considering a certain EDFAs working point configuration of gain and tilt targets, a single optical line measurement comprises the set of EDFA monitoring information and OSA measurement. The latter is post-processed to obtain the signal and ASE power profiles at the receiver. The objective of the first step is to locally change the properties of each device—gain ripple profile and noise figure for EDFAs, or stimulated Raman scattering (SRS) for optical fibers—modifying the working point of the EDFAs and measuring the accumulation of the effects using the OSA.

First, the optical line is set in transparency configuration, where each EDFA recovers the loss introduced by the previous span. If not specified, all EDFAs are set at the same tilt value making flat the spectrum profile at the receiver for the set booster gain.

Two datasets are collected focused on the calibration of different groups of physical parameters. To obtain the first dataset, start by configuring the EDFAs to operate in Transparency Mode. For each predefined wavelength, set the appropriate channel using the multiplexer (MUX), and then measure the input and output power of each EDFA. This process will provide the necessary data to analyze attenuation as a function of frequency. For the second dataset, begin by configuring the EDFAs in the Noise Figure Reference Mode. Once this is set, gather line telemetry data using both the EDFAs and an Optical Spectrum Analyzer (OSA). Next, switch the EDFAs back to Transparency Mode and collect the telemetry data again. For each EDFA in the line, adjust the gain settings over a specified range, and within each gain setting, vary the tilt across a defined range. After each adjustment, record the telemetry data. Once all configurations have been tested, reset the EDFAs to Transparency Mode. This procedure will yield a comprehensive dataset that covers both noise figure and gain-tilt performance across the optical line. The total number of measurements for the second dataset is 2+nG*nT*NEDFA, where NEDFA is the number of EDFAs along the line, nG and nT are the chosen numbers of gain and tilt values defining the granularity of the third dataset.

The second step (digital model calibration) involves the use of the two datasets and aims to calibrate the digital model physical parameters throughout a feature extraction process based on following extraction algorithm. Using the first dataset, the total fiber attenuation is calculated by subtracting the output power (Pin) from the input power (Pout) for each channel and span. This allows for the creation of an attenuation profile over frequency for each span, providing insights into how the signal weakens over the transmission line.

Using the second dataset, the physical parameters of the fiber and gain are determined by analyzing the variations of each EDFA in the line, starting from the last to the first. For each EDFA, measurements are grouped for varying target parameters, gain (G) and tilt (T). For each target parameter, numerical derivatives of the selected EDFA to these parameters are computed considering the measured signal power profiles and target parameter setting variations. Then, the algorithm considers the measures related to the previous EDFA with respect to the selected one with the gain target setting varying. Assuming a flat spectrum at the input of the fiber span in between the two amplifiers, the fiber parameters (input/output connector losses), are fitted to match the signal power spectrum variation at the end of the line.

The same procedure is applied iteratively to all the optical line spans up to the booster amplifier. Then, the intrinsic gain ripple parameter, g₀, assumed to be the same for all EDFAs, is then fitted for the transparency configuration. For the EDFA noise figure, the average noise figure curve is fitted using the measured spectrum across all configurations, with the curve assumed to be the same for all EDFAs. The fitting is refined for each EDFA, considering the measurements that vary according to specific varying target parameter configurations. To obtain the intrinsic profile of the noise figure, it is fitted (assumed to be identical for all EDFAs) based on the noise figure reference configuration. This configuration is defined setting all EDFAs at a unique value of both gain and tilt target parameters within the granularity grids (nG and nT).

Finally, the noise figure ripple parameters for each EDFA are analyzed by again starting from the last to the first EDFA in the line. Measurements are selected based on varying target parameters for each EDFA. For each target parameter (G and T), the numerical derivatives of the noise figure ripple profile for the selected EDFA are computed with respect to the corresponding target parameter considering the measured amplified spontaneous emission (ASE) power profiles and target parameter

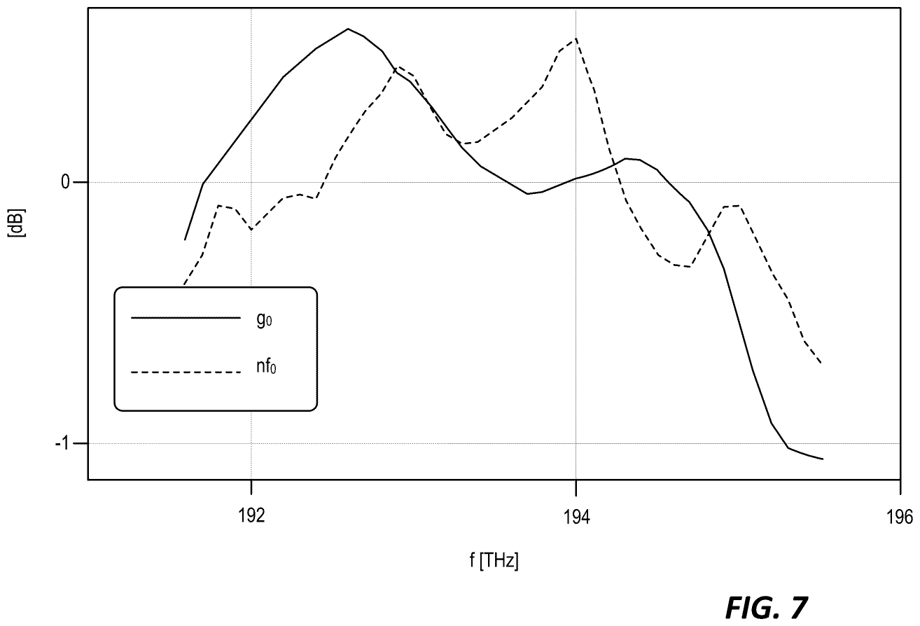

FIG. 7 is a plot showing illustrative physical parameters extracted intrinsic ripple profile, gain, g₀, and noise figure, nf₀ according to aspects of the present invention.

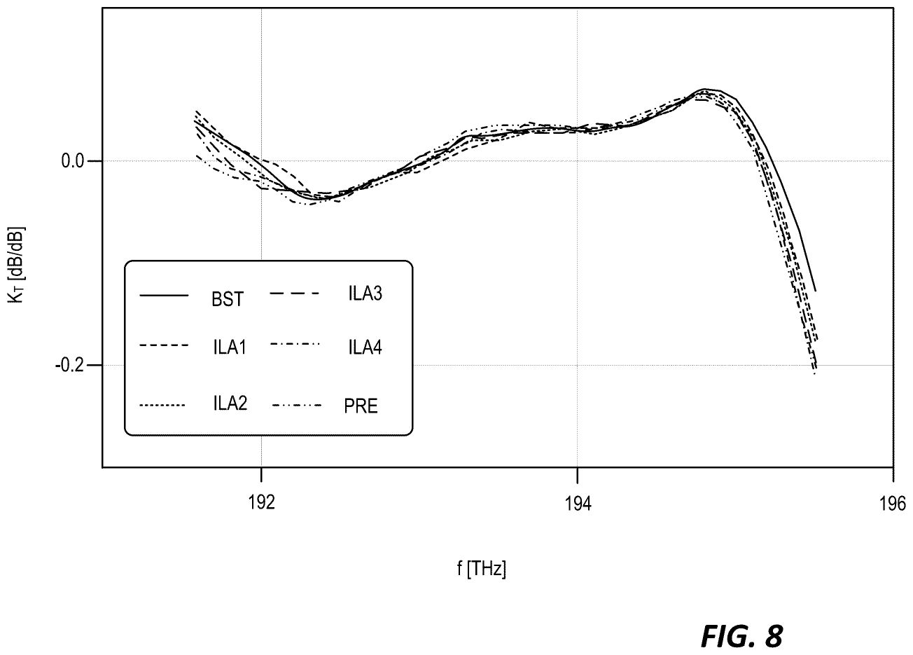

FIG. 8 is a plot showing illustrative physical parameters extracted of gain ripple first derivative vs. tilt target according to aspects of the present invention.

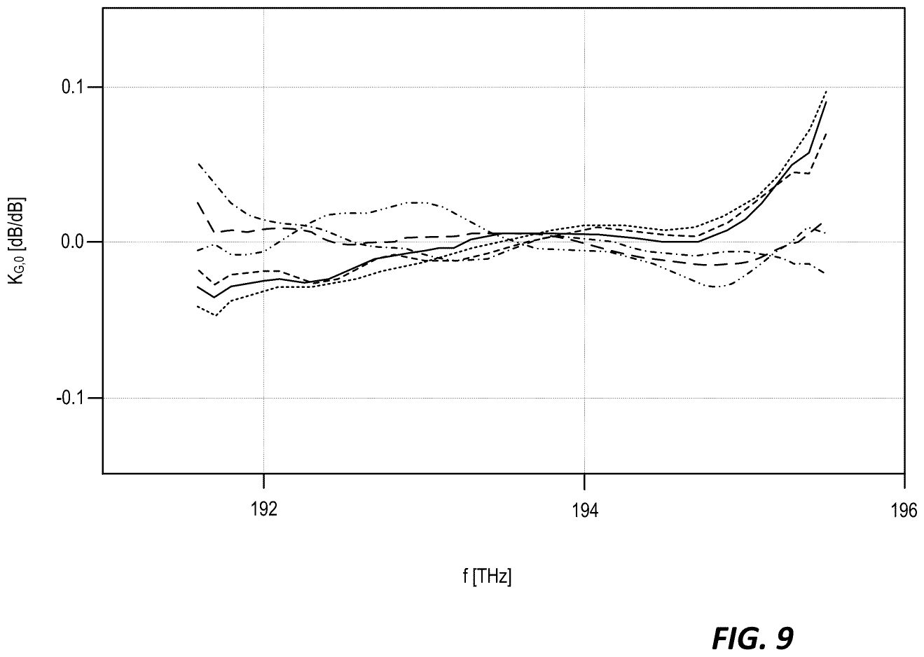

FIG. 9 is a plot showing illustrative physical parameters extracted of initial value of the gain ripple first derivative vs. gain target according to aspects of the present invention.

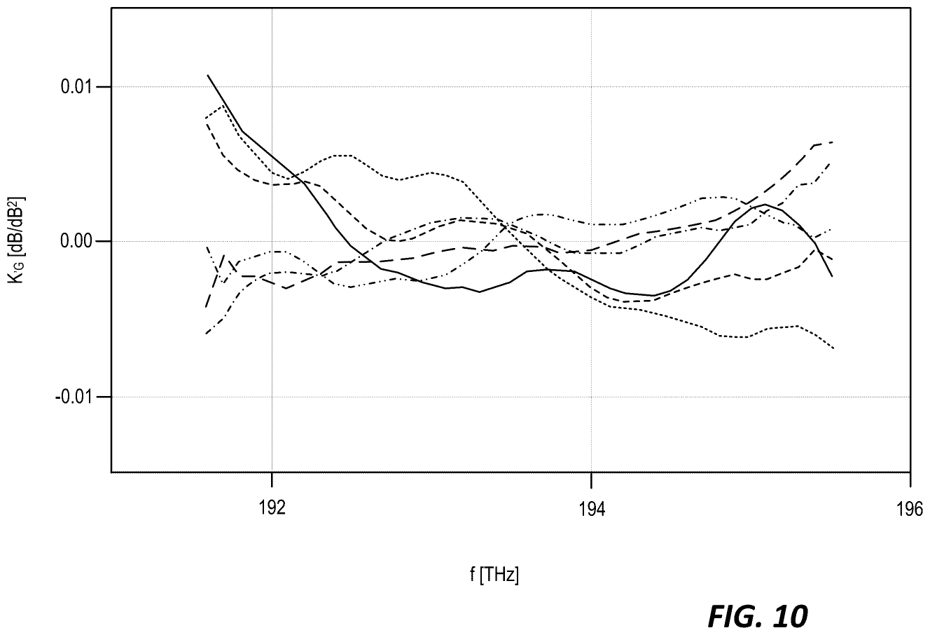

FIG. 10 is a plot showing illustrative physical parameters extracted of gain ripple second derivative vs gain target according to aspects of the present invention.

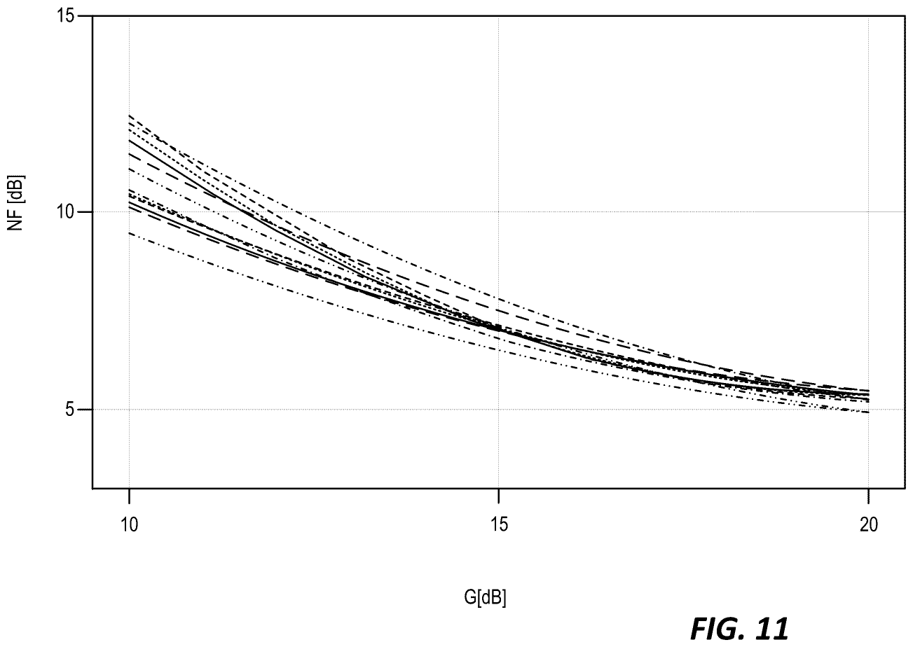

FIG. 11 is a plot showing illustrative physical parameters extracted of average noise figure curve vs gain and tilt target according to aspects of the present invention.

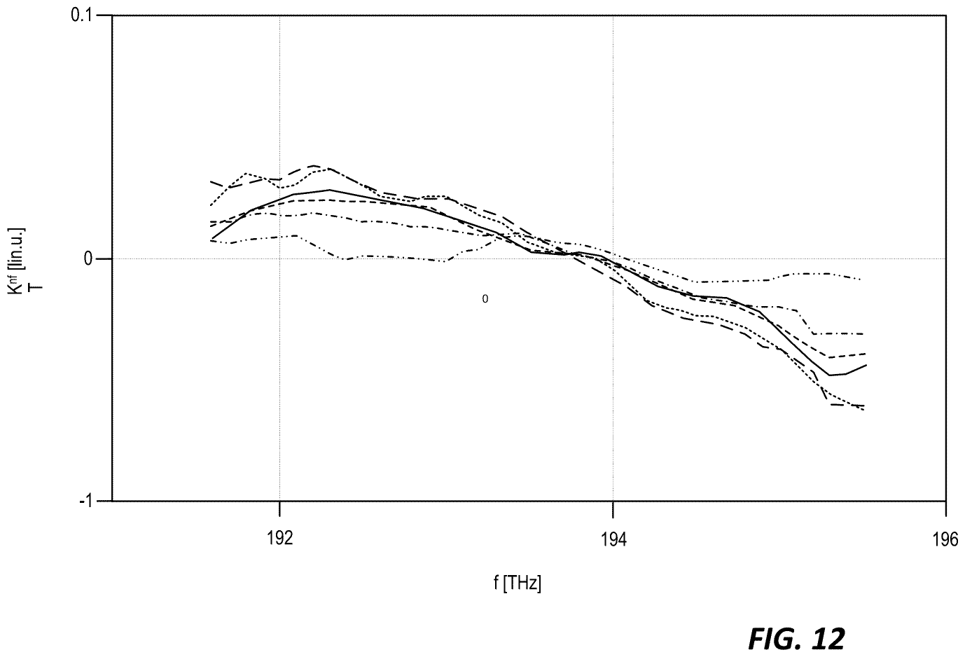

FIG. 12 is a plot showing illustrative physical parameters extracted of noise figure ripple first derivative vs tilt target according to aspects of the present invention.

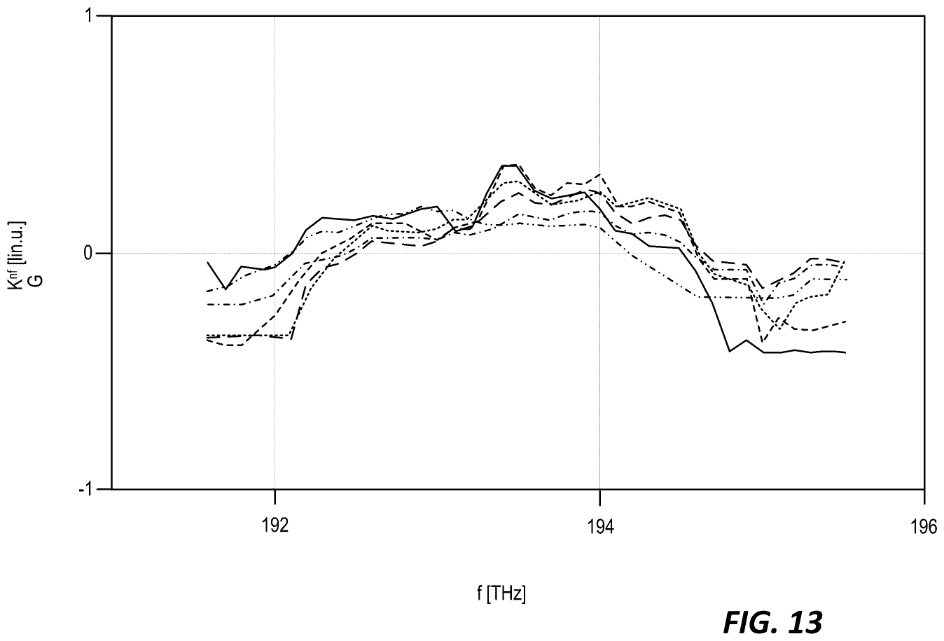

FIG. 13 is a plot showing illustrative physical parameters extracted of noise figure ripple first derivative vs gain target according to aspects of the present invention.

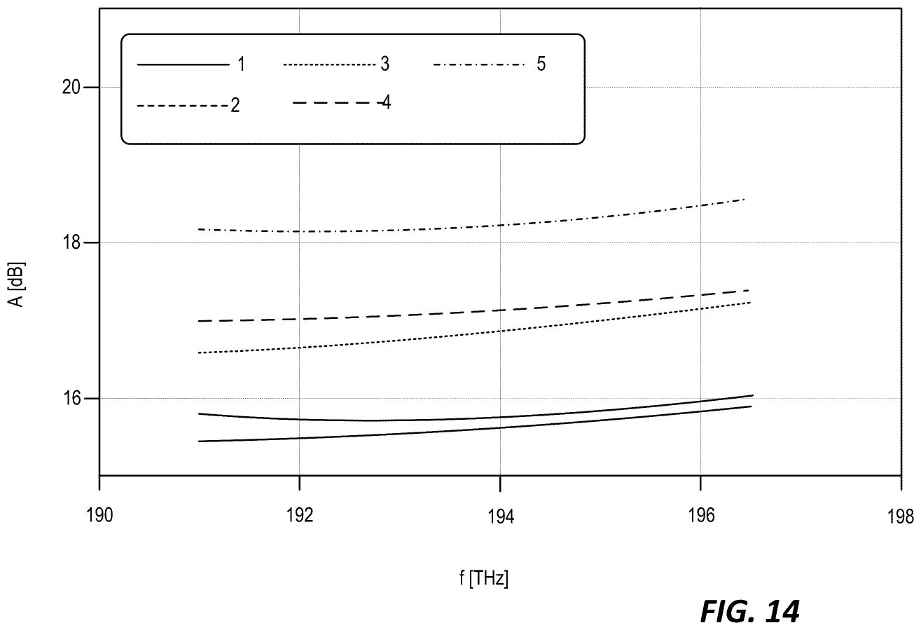

FIG. 14 is a plot showing illustrative physical parameters extracted noise figure ripple first derivative vs gain target according to aspects of the present invention.

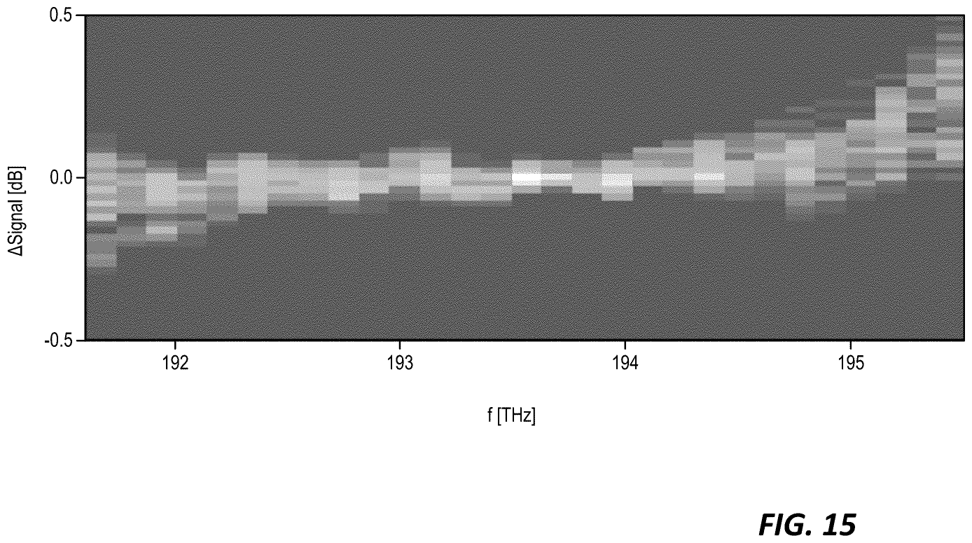

FIG. 15 is a plot showing illustrative experimental results obtained on a validation dataset of 100 measurements with random chosen combination of EDFA target setting for heat maps of signal and OSNR error over frequency in which all results have been achieved collecting a validation dataset of 100 measurements for every OLS according to aspects of the present invention.

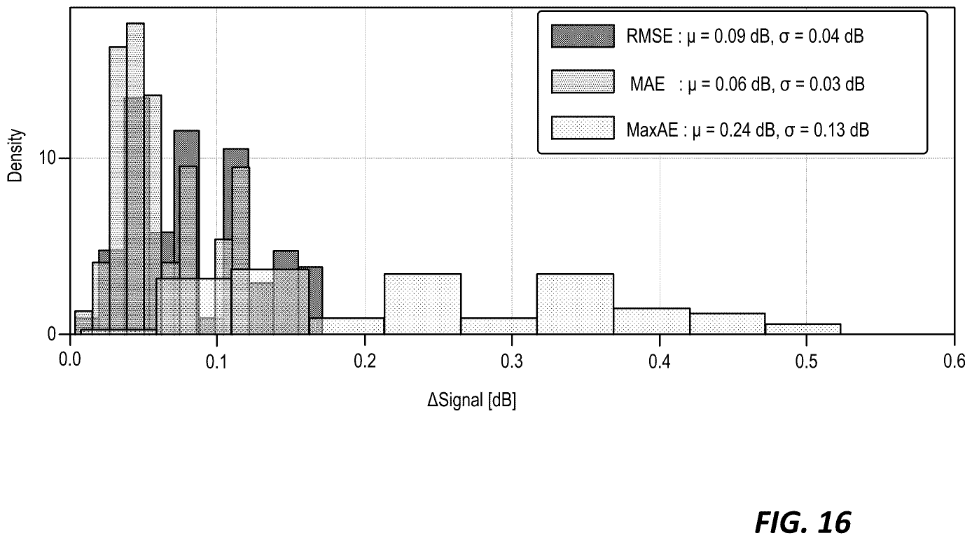

FIG. 16 is a plot showing illustrative experimental results obtained on a validation dataset of 100 measurements with random chosen combination of EDFA target setting for distributions of signal and OSNR error using different metrics in which all results have been achieved collecting a validation dataset of 100 measurements for every OLS according to aspects of the present invention.

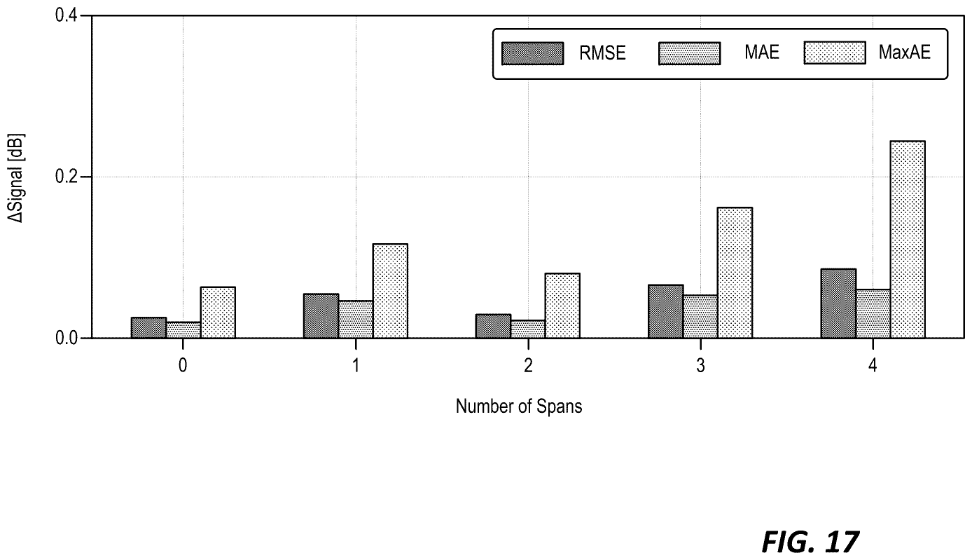

FIG. 17 is a plot showing illustrative experimental results obtained on a validation dataset of 100 measurements with random chosen combination of EDFA target setting for histograms of the average metrics for signal and OSNR error incrementing histograms of the average metrics for signal and OSNR error incrementing the number of spans in the OLS in which all results have been achieved collecting a validation dataset of 100 measurements for every OLS according to aspects of the present invention.

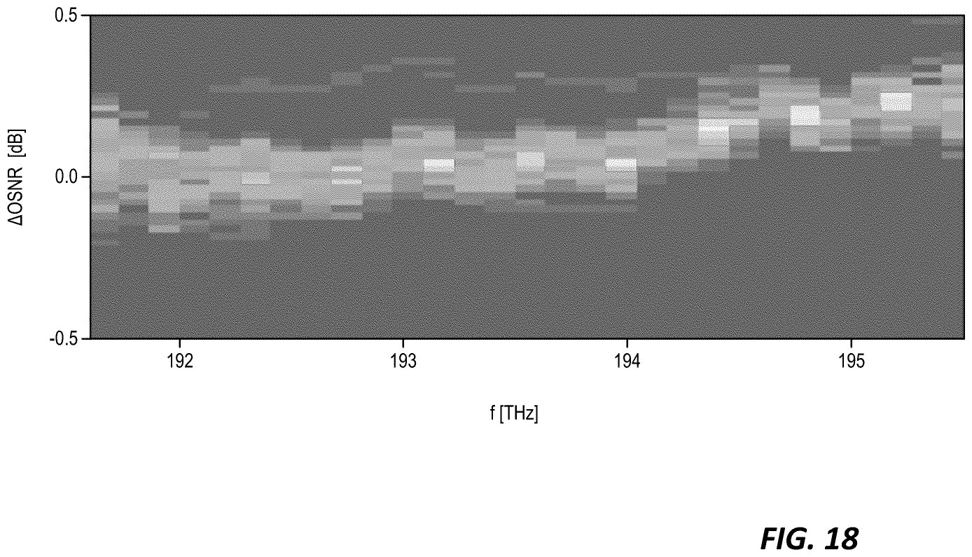

FIG. 18 is a plot showing illustrative experimental results obtained on a validation dataset of 100 measurements with random chosen combination of EDFA target setting for heat maps of signal and OSNR error over frequency in which all results have been achieved collecting a validation dataset of 100 measurements for every OLS according to aspects of the present invention.

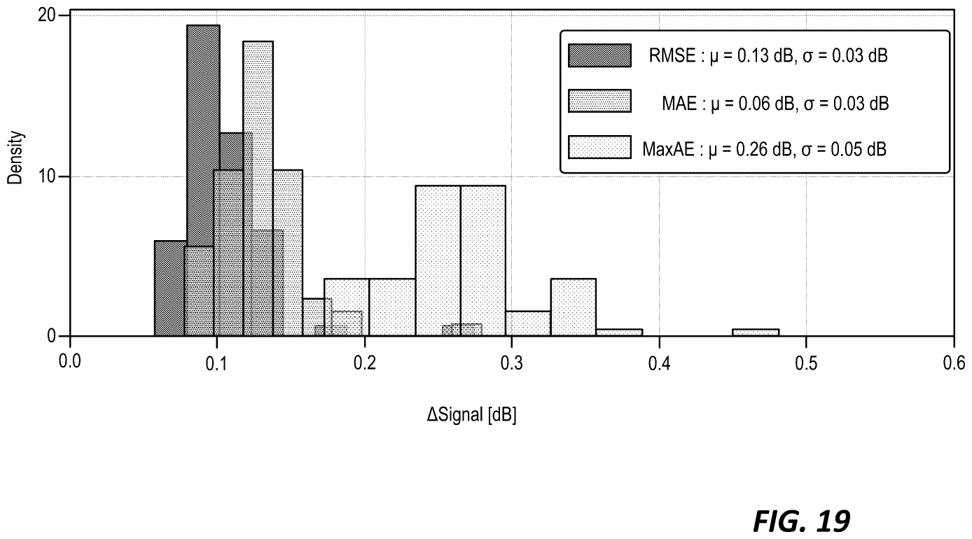

FIG. 19 is a plot showing illustrative experimental results obtained on a validation dataset of 100 measurements with random chosen combination of EDFA target setting for distributions of signal and OSNR error using different metrics in which all results have been achieved collecting a validation dataset of 100 measurements for every OLS according to aspects of the present invention.

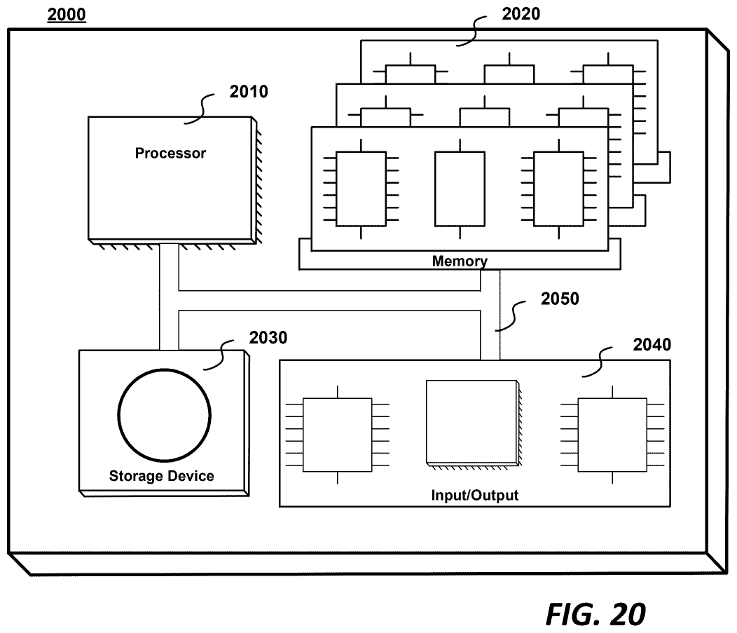

FIG. 20 is a plot showing illustrative experimental results obtained on a validation dataset of 100 measurements with random chosen combination of EDFA target setting for histograms of the average metrics for signal and OSNR error incrementing histograms of the average metrics for signal and OSNR error incrementing the number of spans in the OLS in which all results have been achieved collecting a validation dataset of 100 measurements for every OLS according to aspects of the present invention.

Finally FIG. 21 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 2100 as stored program control instructions.

Computer system 2100 includes processor 2110, memory 2120, storage device 2130, and input/output structure 2140. One or more input/output devices may include a display. One or more busses 2150 typically interconnect the components, 2110, 2120, 2130, and 2140. Processor 2110 may be a single or multi core. Additionally, the system may include accelerators etc., further comprising a system on a chip.

Processor 2110 executes instructions in which embodiments of the present disclosure may comprise steps described in one or more of the Drawing figures. Such instructions may be stored in memory 2120 or storage device 2130. Data and/or information may be received and output using one or more input/output devices.

Memory 2120 may store data and may be a computer-readable medium, such as volatile or non-volatile memory. Storage device 2130 may provide storage for system 2100 including for example, the previously described methods. In various aspects, storage device 2130 may be a flash memory device, a disk drive, an optical disk device, or a tape device employing magnetic, optical, or other recording technologies.

Input/output structures 2140 may provide input/output operations for system 2100.

At this point, those skilled in the art will understand that while we have presented our inventive concepts and description using specific examples, our invention is not so limited. Accordingly, the scope of our invention should be considered in view of the following claims.

1. A computer-implemented method for calibrating a physical digital model of an optical line system (OLS) comprising a plurality of Erbium-Doped Fiber Amplifiers (EDFAs) and optical fiber spans, the method comprising:
acquiring a first dataset of optical measurements of the OLS while the EDFAs are configured in a transparency mode by: (i) measuring an input power and an output power for each EDFA across a plurality of channels; and (ii) calculating a fiber attenuation profile for each optical fiber span from the measured input power and output power values;
acquiring a second dataset of optical measurements of the OLS by: (i) systematically varying a target gain setting and a target tilt setting for at least one EDFA in the plurality of EDFAs across a defined granularity; and (ii) recording line telemetry data for each variation, the line telemetry data comprising a total optical power measurement from a photodetector in each EDFA and an optical spectrum measurement at a line termination;
iteratively extracting physical parameters of the EDFAs and the optical fiber spans by: (i) selecting an EDFA, starting with a last EDFA in the OLS and progressing to a first EDFA; (ii) determining a numerical derivative of a measured power profile derived from the OSA measurement with respect to the varying target gain setting or a varying target tilt setting for the selected EDFA; and (iii) fitting at least one physical parameter of an adjacent optical fiber span or the selected EDFA using the computed numerical derivative to match a variation in the measured power profile; and
calibrating the physical digital model of the OLS using the extracted fiber attenuation profile from the first dataset and the iteratively extracted physical parameters from the second dataset.

2. The method of claim 1, wherein the plurality of EDFAs are minimally monitored amplifiers having only integrated photodetectors for total optical power monitoring.

3. The method of claim 1, wherein the power profile derived from the OSA measurement is a signal power profile, and the step of iteratively extracting physical parameters further comprises fitting fiber connector losses of an adjacent optical fiber span using the numerical derivatives of the signal power profile.

4. The method of claim 1, wherein the power profile derived from the OSA measurement is an Amplified Spontaneous Emission (ASE) noise power profile, and the step of iteratively extracting physical parameters further comprises fitting an EDFA noise figure ripple parameter using the numerical derivatives of the ASE noise power profile.

5. The method of claim 1, further comprising: fitting an intrinsic gain ripple parameter, assumed to be identical for all EDFAs, using the line telemetry data acquired while the EDFAs are configured in the transparency mode.

6. The method of claim 1, further comprising: (i) acquiring a set of noise figure reference measurements as part of the second dataset by configuring the EDFAs in a noise figure reference configuration; and (ii) fitting an intrinsic noise figure ripple profile, assumed to be identical for all EDFAs, using the noise figure reference measurements.
